(19) United States
(12) Patent Application Publication
(10) Pub. No.: US 2025/0301299 A1
(43) Pub. Date: Sep. 25, 2025

(54) ELECTRONIC APPARATUS, REGISTRATION PROCESSING METHOD, AND RECORDING MEDIUM

(71) Applicant: CASIO COMPUTER CO., LTD., Tokyo (JP)

(72) Inventors: Hiroyuki KATO, Tokyo (JP); Shogo HASHIMOTO, Tokyo (JP)

(73) Assignee: CASIO COMPUTER CO., LTD., Tokyo (JP)

(21) Appl. No.: 19/083,591

(22) Filed: Mar. 19, 2025

(30) Foreign Application Priority Data
Mar. 22, 2024 (JP) 2024-046050

(51) Int. Cl. H04W 8/00; G01D 21/02

(52) U.S. Cl. CPC H04W 8/005; G01D 21/02

(57) ABSTRACT

Disclosed is an electronic apparatus including: a wireless communicator; and one or more processors that perform a first process of searching for another electronic apparatus via the wireless communicator, a second process of instructing a user to change a posture of the other electronic apparatus in a case in which the searching in the first process is successful, and a third process of registering the other electronic apparatus, a change in the posture of which is detected.

### REFERENCE TO RELATED APPLICATIONS

This application claims priority and benefit of Japanese Patent Application No. 2024-046050, filed on Mar. 22, 2024. The entire specification, claims, and drawings of Japanese Patent Application No. 2024-046050 are incorporated herein by reference.

### TECHNICAL FIELD

The present invention relates to an electronic apparatus, a registration processing method, and a recording medium.

### DESCRIPTION OF RELATED ART

In recent years, various data are sent and received wirelessly between electronic apparatuses that include wireless communication functions such as Bluetooth (registered trademark). For this reason, pairing technology is known to register a communication partner between electronic apparatuses that are to communicate with each other (see JP 2015-517246 A).

### SUMMARY OF THE INVENTION

To address the above issues, according to an aspect of the present invention, there is provided an electronic apparatus comprising:
a wireless communicator; and
one or more processors that perform a first process of searching for another electronic apparatus via the wireless communicator, a second process of instructing a user to change a posture of the other electronic apparatus in a case in which the searching in the first process is successful, and a third process of registering the other electronic apparatus, a change in the posture of which is detected.

### BRIEF DESCRIPTION OF DRAWINGS

FIG. 1 is a block diagram showing the internal configuration of a smartphone and a pet terminal that make up a wireless communication system in an embodiment of the present invention;

FIG. 2 shows an example of the appearance of the pet terminal;

FIG. 3 is a sequence diagram showing the overall registration time process executed on the smartphone and the pet terminal;

FIG. 4 is a sequence diagram showing a terminal search process;

FIG. 5 is a sequence diagram showing a special movement analysis process;

FIG. 6 is a sequence diagram showing a registration process;

FIG. 7 is an example of a terminal search screen displayed on a display unit of the smartphone;

FIG. 8 is an example of a special movement explanation screen displayed on the display unit of the smartphone; and

FIG. 9 is an example of a registration confirmation screen displayed on the display unit of the smartphone.

### DETAILED DESCRIPTION

The following is a description of the embodiment of the present invention with reference to the drawings. In this embodiment, the registration process means the process by which at least one apparatus registers the other apparatus for data communication between electronic apparatuses. The present invention is not limited to the illustrated example.

In recent years, there have been growing expectations for pet-type robots (pet terminals) that imitate animals and other living creatures. To manage pet terminals, the use of user terminals such as smartphones owned by users (pet owners) is conceivable. When data communication between a user terminal and a pet terminal is performed via Bluetooth or other wireless communication, a registration process must also be performed in advance.

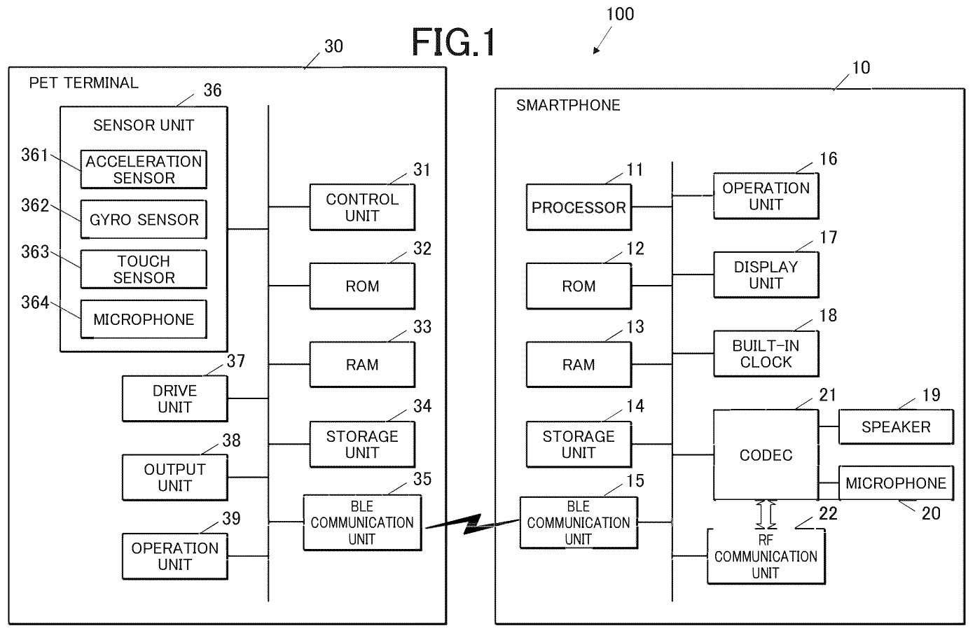

As shown in FIG. 1, the wireless communication system 100 consists of a smartphone 10 as the first electronic apparatus and a pet terminal 30 as the second electronic apparatus. The pet terminal 30 is a robot that can express the appearance and motions of a living creature. The pet terminal 30 includes AI (Artificial Intelligence), and the pet terminal 30 has learning functions such as expanding the variation of its behavior and improving its ability to communicate with the user. The smartphone 10 and the pet terminal 30 both include short-range wireless communication functions and can communicate with each other via BLE (Bluetooth Low Energy) communication. In FIG. 1, one smartphone 10 and one pet terminal 30 are illustrated, but the number of smartphones 10 and pet terminals 30 is not limited to this.

The smartphone 10 has a processor 11, a ROM (Read Only Memory) 12, a RAM (Random Access Memory) 13, a storage unit 14, a BLE communication unit 15, an operation unit 16, a display unit 17, a built-in clock 18, and a speaker 19, a microphone 20, a codec 21, and an RF communication unit 22.

The processor 11 includes a CPU (Central Processing Unit). The processor 11 performs supervisory control of the overall movement of the smartphone 10 and various arithmetic processes. Specifically, the processor 11 reads various processing programs stored in the ROM 12 or the storage unit 14, develops them in the RAM 13, and performs various processes in cooperation with the programs. The processor 11 may perform processes by a single CPU, or multiple CPUs may operate in parallel or independently depending on the usage. The ROM 12 is a read-only semiconductor memory that stores various programs and data to be executed by the processor 11. The RAM 13 provides a working memory space for the processor 11 to store temporary data for work.

The storage unit 14 is composed of nonvolatile memory or the like, and stores information in a readable and writable manner. The storage unit 14 stores, for example, various application programs executed by the smartphone 10 and data pertaining to various functions. Specifically, the storage unit 14 stores a pet management application program. The functions realized by the cooperation between the processor 11 and the pet management application program are referred to as “pet management applications”. The pet management application is used, for example, when the user checks the current emotions and movement history of the pet terminal 30. In addition, the storage unit 14 stores the pet terminal ID of the pet terminal 30 registered in the pet management application and the key information (authentication key) generated for the pet terminal 30 so as to be associated with each other. The pet terminal ID is identification information unique to each pet terminal 30 (identification information to uniquely identify a pet terminal 30). Key information is information used to identify the communication partner in BLE communication. Key information includes identification information to identify the smartphone 10, keys for encrypting data, and the like. The pair of pet terminal ID and key information is the registration information saved on the smartphone 10 side.

The BLE communication unit 15 (wireless communicator) communicates data with other electronic apparatuses, such as the pet terminal 30, via an antenna for transmitting and receiving BLE communications, using the BLE communication method. The operation unit 16 includes various buttons and the like that accept input operations by the user, and outputs operation signals based on user operations to the processor 11. The operation unit 16 includes a touch panel on the display screen of the display unit 17, which detects the position of a touch operation by the user's finger or other apparatus and outputs an operation signal corresponding to that position to the processor 11. The display unit 17 consists of an LCD (Liquid Crystal Display) or the like, and displays screens according to display control signals from the processor 11. The display unit 17 displays the operation screen, the processing results executed by the smartphone 10, and other information.

The built-in clock 18 is a counter that counts and holds the current time. The current time data of the built-in clock 18 is revised from time to time during communication with the mobile base station by the RF communication unit 22. The speaker 19 converts electrical signals into audio signals based on signals from the codec 21 and outputs audio. The microphone 20 detects sound waves, converts them into electrical signals, and outputs them to the codec 21. The codec 21 decodes the encoded and compressed digital audio signal and transmits it as an analog signal to the speaker 19, and encodes the audio signal output from the microphone 20 and outputs it to the processor 11 or the RF communication unit 22. The RF communication unit 22 transmits and receives packet data such as telephone voice data and e-mail to and from the mobile base station using an antenna for RF transmission and reception.

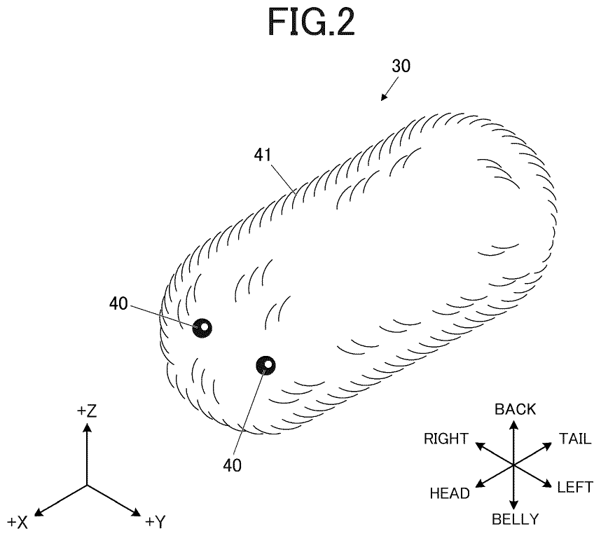

As shown in FIG. 2, the pet terminal 30 is covered by an exterior including parts 40 that resemble eyes and fluffy hairs 41. Hereafter, the direction connecting the part corresponding to the head and the part corresponding to the tail of the pet terminal 30 (head-tail direction) is the X-axis direction (+X for the head side). When the pet terminal 30 is placed on a flat surface (such as the floor) in a prone state, the direction perpendicular to the X-axis direction and parallel to the flat surface is the Y-axis direction (+Y on the left side looking in the +X direction). The direction perpendicular to the X-axis direction and perpendicular to the Y-axis direction, that is, the direction connecting the portions corresponding to the back and belly of the pet terminal 30 (back-belly direction), is the Z-axis direction (+Z for the back side).

As shown in FIG. 1, the pet terminal 30 has a control unit 31, a ROM 32, a RAM 33, a storage unit 34, a BLE communication unit 35, a sensor unit 36, a drive unit 37, an output unit 38, and an operation unit 39. The control unit 31 includes a CPU. The control unit 31 performs supervisory control of the overall movement of the pet terminal 30 and various arithmetic processes. Specifically, the control unit 31 reads various processing programs stored in the ROM 32, develops them in the RAM 33, and performs various processes in cooperation with the programs. The control unit 31 may perform processes by a single CPU, or multiple CPUs may operate in parallel or independently depending on the usage.

The ROM 32 is a read-only semiconductor memory that stores various programs and data to be executed by the control unit 31. For example, the ROM 32 stores programs, setting data, and the like for the pet terminal 30 to behave like a pseudo pet. Setting data includes emotion data, a growth table, and a movement content table. Emotion data is data to give the pet terminal 30 a pseudo-emotion. Emotional data is represented by numerical values indicating joy, happiness, sadness, frustration, and the like. It also defines how each value of the emotion data changes in response to external stimuli, and the like detected by the sensor unit 36. The growth table associates the types of movements (gestures) performed by the pet terminal 30 using external stimuli, and the like detected by the sensor unit 36 as movement triggers, and the probability that each movement is selected according to the growth value. The growth value is a value indicating the pseudo-growth degree of the pet terminal 30. The movement content table records the specific movement contents of each movement type. The RAM 33 provides the control unit 31 with a working memory space to store temporary data for work.

The storage unit 34 is composed of nonvolatile memory or the like and stores information in a readable and writable manner. For example, the storage unit 34 stores the pet terminal ID of the pet terminal 30 itself. The key information corresponding to the smartphone 10 registered as the communication partner is stored in the storage unit 34. The key information is registration information saved on the pet terminal 30 side. In addition, sensor history, movement history, emotion history, and the like are stored in the storage unit 34. The sensor history is data that associates the detected values (external stimuli) detected by the sensor unit 36 with the date and time of detection. The movement history is data that associates each movement at the pet terminal 30 with the date and time the movement was performed. The emotion history is data that associates the emotions that occurred in the pet terminal 30 with the date and time of their occurrence.

The BLE communication unit 35 (wireless communicator) communicates data with other electronic apparatuses, such as the smartphone 10, via an antenna for transmitting and receiving BLE communications, using the BLE communication method. The sensor unit 36 includes an acceleration sensor 361, a gyro sensor 362, a touch sensor 363, a microphone 364, and the like. The sensor unit 36 outputs the detected values detected by various sensors to the control unit 31 as external stimulus data indicating external stimuli to the pet terminal 30. The acceleration sensor 361 detects acceleration in three axial directions, consisting of the head-tail direction (X-axis direction), left-right direction (Y-axis direction), and back-belly direction (Z-axis direction) of the pet terminal 30. The gyro sensor 362 detects the angular velocity associated with the rotation of the pet terminal 30. For example, the gyro sensor 362 detects the angular velocity with the head-tail direction (X-axis direction), left-right direction (Y-axis direction), and back-belly direction (Z-axis direction) axes of the pet terminal 30, respectively. The control unit 31 detects the posture and motion of the pet terminal 30 based on the detected values of at least one of the acceleration sensor 361 and the gyro sensor 362. The touch sensor 363 detects that an object has contacted the pet terminal 30. The touch sensor 363 is composed of, for example, a pressure sensor or a capacitance sensor. The control unit 31 detects that the pet terminal 30 has been stroked by the user based on the detected values of the touch sensor 363. The microphone 364 detects sounds around the pet terminal 30. The control unit 31 detects vocalizations, applause, and the like by the user based on the detected values of the microphone 364. The sensor unit 36 may also include an illuminance sensor to detect ambient illuminance and a temperature sensor to detect ambient temperature.

The drive unit 37 includes motors and other apparatuses to move the various parts of the pet terminal 30. The drive unit 37 expresses the movement of the pet terminal 30 as if it were lifting its head or rolling. When the pet terminal 30 includes a part corresponding to a leg, the drive unit 37 expresses motions corresponding to the part included in the pet terminal 30, such as bending and stretching of the leg or walking movements. The output unit 38 includes a speaker and outputs sounds such as squeals. The output unit 38 may include a display, such as an LCD, or a light emitter, such as a Light Emitting Diode (LED). The operation unit 39 includes a power button, operation buttons, and the like, and outputs operation signals based on user operations to the control unit 31.

The following is an overview of the present invention. Only one smartphone 10 can be registered to the pet terminal 30 as a communication partner. Once a specific communication partner is registered to the pet terminal 30, the user holding the registered smartphone 10 becomes a pseudo owner and can execute some process on the pet terminal 30 via the smartphone 10. On the other hand, the smartphone 10 can register multiple pet terminals 30 as communication partners. The smartphone 10 can connect to multiple pet terminals 30 simultaneously via the BLE communication unit 15.

The processor 11 of the smartphone 10 (first electronic apparatus, electronic apparatus) performs a terminal search process (first process) to search for the pet terminal 30 (second electronic apparatus, another electronic apparatus) via the BLE communication unit 15. If the search in the terminal search process is successful, the processor 11 performs a second process that instructs the user to change the posture of the pet terminal 30. The processor 11 performs the registration process (third process) of registering the pet terminal 30, a change in posture of which was detected.

The processor 11 causes the display unit 17 to display information indicating that the terminal search process is being executed at the execution of the terminal search process. Here, “at the execution of the terminal search process” may be at the start of the terminal search process or while the terminal search process is being executed. The “information indicating that the terminal search process is being executed” may include information indicating that the terminal search process is about to start. The processor 11 causes the display unit 17 to display an image instructing the user to change the posture of the pet terminal 30 in the second process after the completion of the terminal search process.

The processor 11 determines whether or not a change in posture in the pet terminal 30 was detected (special movement analysis process). The change in posture is achieved by the user placing the pet terminal 30 in a predetermined posture position after the terminal search process. For example, the processor 11 detects changes in posture at the pet terminal 30 based on the output results of the acceleration sensor 361 or the gyro sensor 362 provided in the pet terminal 30.

When the processor 11 of the smartphone 10 detects a change in posture at the pet terminal 30, it causes the pet terminal 30 to register the smartphone 10 as a communication partner. Here, the processor 11 generates key information (authentication key) to identify the smartphone 10 and transmits the key information to the pet terminal 30.

The smartphone 10 is a communication terminal that transmits predetermined instructions to the pet terminal 30. Here, “predetermined instructions” may include instructions for the pet terminal 30 to perform physical movements such as lifting its head, rolling over, walking, and the like, as well as instructions to change facial expressions, emotions, and the like. The “predetermined instructions” may also be instructions to suck up various data from the pet terminal 30. The processor 11 of the smartphone 10 transmits predetermined instructions to the pet terminal 30 via the BLE communication unit 15 in response to operations by the user from the operation unit 16. The pet terminal 30 is a robotic terminal that operates by receiving predetermined instructions from the smartphone 10. When the control unit 31 of the pet terminal 30 receives predetermined instructions from the smartphone 10 via the BLE communication unit 35, it causes the various parts of the pet terminal 30 to perform various movements according to those instructions.

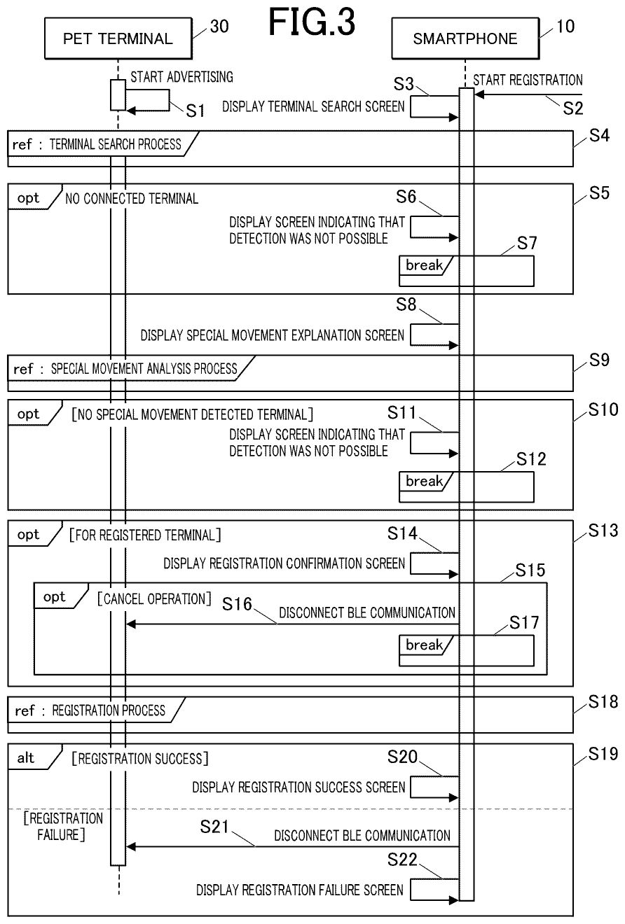

The operation in the wireless communication system 100 is described next with reference to FIGS. 3 to 6. In BLE communication, the smartphone 10 is the central apparatus and the pet terminal 30 is the peripheral apparatus. As shown in FIG. 3, in the overall registration time process, when the user operates the operation unit 39 of the pet terminal 30 to instruct it to enter the registration mode, the control unit 31 starts advertising (step S1). Specifically, at predetermined time intervals, the control unit 31 sends out advertisement signals via the BLE communication unit 35 to place it in a connection waiting state.

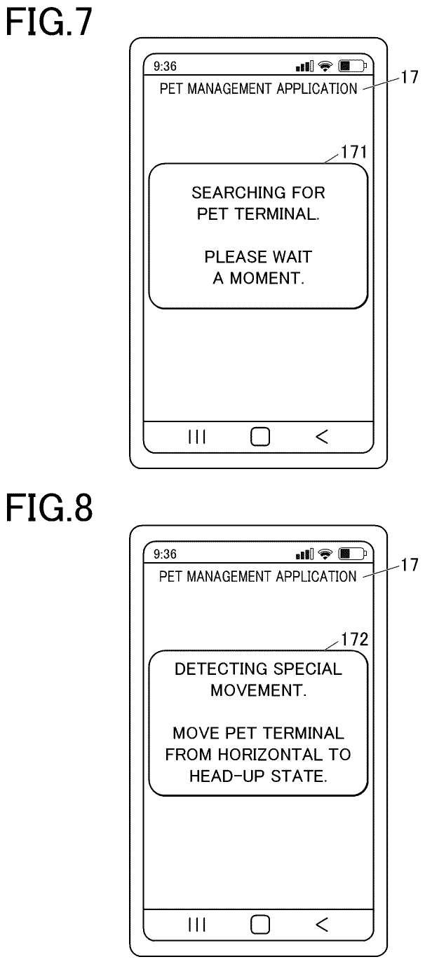

On the smartphone 10, when the user operates the operation unit 16 to instruct the start of registration of the pet terminal 30 on the pet management application (step S2), the processor 11 causes the display unit 17 to display the terminal search screen 171 shown in FIG. 7 (step S3). The terminal search screen 171 indicates that a search for the pet terminal 30 is in progress. The terminal search screen 171 is displayed on the display unit 17, for example, until the terminal search process (step S4) is completed. The user recognizes that it is in the search phase of the pet terminal 30 by the terminal search screen 171.

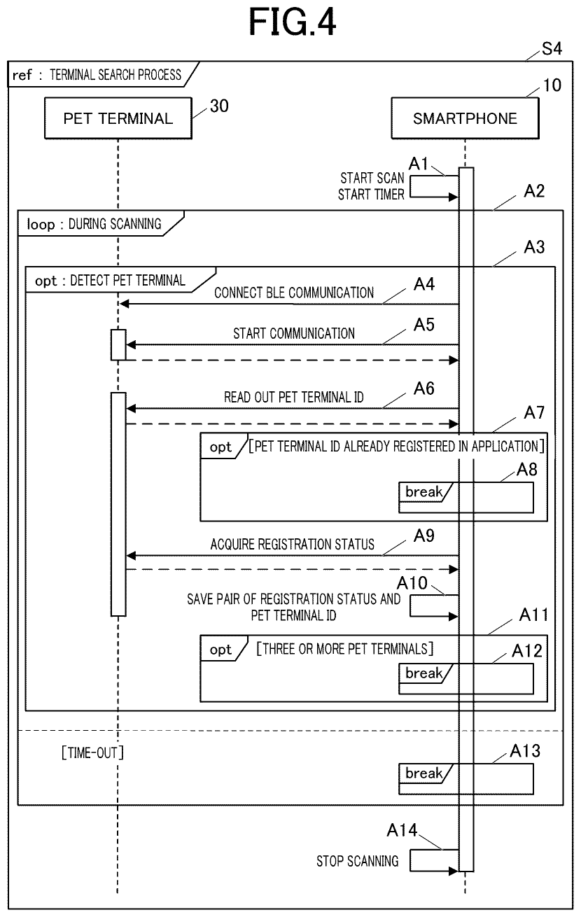

Next, the processor 11 of the smartphone 10 executes the terminal search process (step S4). The terminal search process is the process of searching for the pet terminal 30 by scanning via BLE communication. As shown in FIG. 4, in the terminal search process, the processor 11 places the BLE communication unit 15 in a receiving state, starts scanning, and starts timer measuring based on the built-in clock 18 (step A1). The processor 11 searches for the pet terminal 30 (peripheral apparatus) waiting for connection by the BLE communication unit 15.

The processor 11 in the smartphone 10 repeats the process in step A2 during the scan. The processor 11 performs the process in step A3 if it detects the pet terminal 30 via the BLE communication unit 15 during the scan. In step A3, the processor 11 first connects to the detected pet terminal 30 via the BLE communication unit 15 (step A4) and starts communication with the pet terminal 30 (step A5).

Next, the processor 11 of the smartphone 10 reads out the pet terminal ID from the connected pet terminal 30 via the BLE communication unit 15 (step A6). Specifically, the processor 11 transmits a request to the connected pet terminal 30 via the BLE communication unit 15 to acquire the pet terminal ID of the pet terminal 30 itself. When the control unit 31 of the pet terminal 30 receives the request to acquire the pet terminal ID via the BLE communication unit 35, it reads out the pet terminal ID from the storage unit 34. The control unit 31 transmits the read-out pet terminal ID to the smartphone 10 via the BLE communication unit 35.

Here, the processor 11 of the smartphone 10 determines whether or not the pet terminal ID acquired from the connected pet terminal 30 is a pet terminal ID that has already been registered in the pet management application. The processor 11 determines whether or not the pet terminal ID of the connected pet terminal 30 is stored in the storage unit 14 as registration information (pet terminal ID and key information) pertaining to the pet terminal 30 managed in the pet management application. If the pet terminal ID acquired from the connected pet terminal 30 is the pet terminal ID that has already been registered in the pet management application (step A7), the processor 11 breaks the process of step A3 (step A8).

If the pet terminal ID read in step A6 is not the pet terminal ID already registered in the pet management application, the processor 11 of the smartphone 10 acquires the registration status of the communication partner from the connected pet terminal 30 via the BLE communication unit 15 (step A9). Specifically, the processor 11 transmits a request to the connected pet terminal 30 via the BLE communication unit 15 to acquire the registration status. When the control unit 31 of the pet terminal 30 receives the request to acquire the registration status via the BLE communication unit 35, it determines whether or not the communication partner is registered. Specifically, the control unit 31 determines whether or not key information is stored in the storage unit 34. If the key information is stored in the storage unit 34, the control unit 31 determines that the communication partner is registered. If the key information is not stored in the storage unit 34, the control unit 31 determines that the communication partner is not registered. The control unit 31 transmits the registration status (whether or not the communication partner is registered) to the smartphone 10 via communication unit 35. The processor 11 of the smartphone 10 saves the registration status (unregistered/registered) and the pet terminal ID acquired from the connected pet terminal 30 in the connected terminal list in the RAM 13 so as to be associated with each other (step A10). The correspondence relationship (pairs) between the pet terminal IDs of the detected pet terminals 30 (excluding those registered in the pet management application) and their registration statuses will be added to the connected terminal list.

Here, the processor 11 of the smartphone 10 determines whether or not there are three or more pet terminals 30 connected to the smartphone 10. Specifically, the processor 11 determines whether or not there are three or more pairs of data saved in the connected terminal list. If there are three or more pet terminals 30 connected to the smartphone 10 (step A11), the processor 11 breaks the process of step A2 (step A12).

During scanning (step A2), the processor 11 of the smartphone 10 breaks the process of step A2 (step A13) if a predetermined time (for example, 5 seconds) has elapsed since the timer started measuring in step A1. The processor 11 stops scanning by the BLE communication unit 15 (step A14) after exiting the process in step A2 at step A12 or step A13. Then, the terminal search process ends.

Returning to FIG. 3, the processor 11 of the smartphone 10 determines whether or not there is a connected pet terminal 30 (the pet terminal 30 found by the search) as a result of the terminal search process. If there are no connected pet terminals 30 (step S5), the processor 11 causes the display unit 17 to display a screen indicating that detection was not possible (step S6). The screen indicating that detection was not possible displays the fact that pet terminals 30 that are candidates for registration target could not be detected in the vicinity of the smartphone 10. The processor 11 breaks the overall registration time process (step S7).

After the terminal search process (step S4), if there is a connected pet terminal 30, the processor 11 of the smartphone 10 causes the display unit 17 to display the special movement explanation screen 172 shown in FIG. 8 (step S8). The special movement explanation screen 172 displays that a special movement is being detected and the explanation of the procedure for performing the special movement. The special movement explanation screen 172 is displayed on the display unit 17, for example, until the special movement analysis process (step S9) is completed. The user understands the special movement procedure and recognizes that it is in the detection phase of the special movement by the special movement explanation screen 172.

Next, the processor 11 of the smartphone 10 executes the special movement analysis process (step S9). The special movement analysis process is the process of analyzing whether or not the pet terminal 30 has performed a special movement. The processor 11 analyzes whether or not the user has moved the pet terminal 30 so that the pet terminal 30 is in a predetermined posture position. It is desirable that the “predetermined posture position” of the pet terminal 30 is a posture position such that the pet terminal 30 is not naturally in that pose unless the user consciously moves it. For example, a “special movement” is a movement that changes from a posture in which the head-tail direction (X-axis direction) and left-right direction (Y-axis direction) of the pet terminal 30 are included in the horizontal plane (horizontal state) to a posture in which the head of the pet terminal 30 (+X direction shown in FIG. 2) is vertically in the upper side (vertical state). The horizontal and vertical directions can be identified from the direction of gravitational acceleration, which can be obtained from the output results of the acceleration sensor 361 or the gyro sensor 362. The operation corresponding to the special movement is for the user to determine the communication partner from among the pet terminals 30 that are candidates for the communication partner of the smartphone 10.

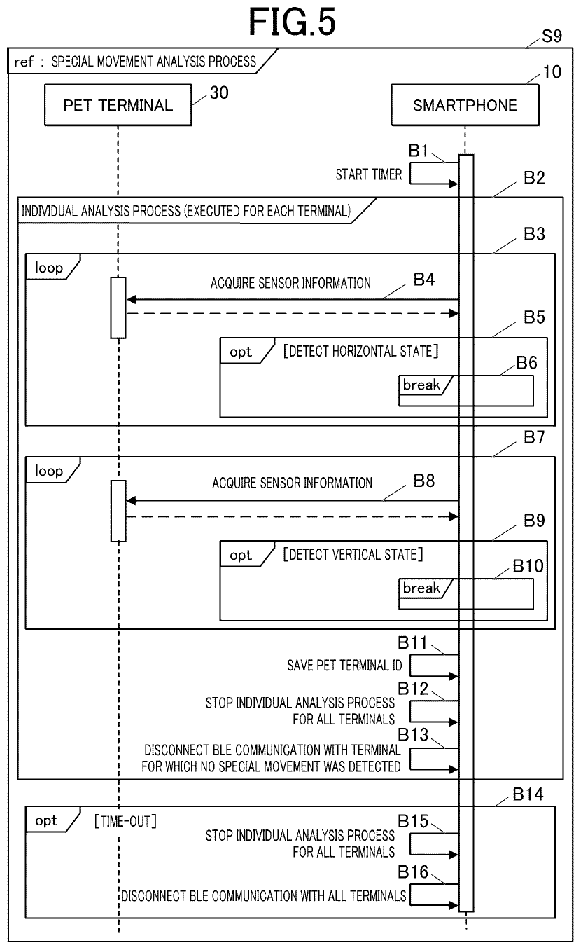

As shown in FIG. 5, in the special movement analysis process (step S9), the processor 11 of the smartphone 10 starts timer measuring based on the built-in clock 18 (step B1). The processor 11 then executes the individual analysis process for each of the connected pet terminals 30 (step B2). The processor 11 treats each pet terminal 30 corresponding to each pet terminal ID in the connected terminal list in the RAM 13 as the process target of the individual analysis process.

In the individual analysis process, the processor 11 of the smartphone 10 repeats the process of step B3. The processor 11 acquires sensor information from the pet terminal 30 which is the process target via the BLE communication unit 15 (step B4). Specifically, the processor 11 transmits a request to the pet terminal 30 which is the process target to acquire the sensor information via the BLE communication unit 15. When the control unit 31 of the pet terminal 30 receives the request to acquire the sensor information via the BLE communication unit 35, it transmits the output values of the sensor unit 36 to the smartphone 10. The processor 11 of the smartphone 10 analyzes whether or not the pet terminal 30 is in the horizontal state based on the sensor information (output results of the acceleration sensor 361 and the gyro sensor 362) acquired from the pet terminal 30. If the processor 11 detects that pet terminal 30 is in the horizontal state (step B5), it breaks the process of step B3 (step B6).

After the horizontal state at the pet terminal 30 was detected, the processor 11 of the smartphone 10 repeats the process of step B7. The processor 11 acquires the sensor information from the pet terminal 30 which is the process target via the BLE communication unit 15 (step B8). The method of acquiring the sensor information is similar to the process in step B4. The processor 11 analyzes whether or not the pet terminal 30 is in the vertical state (head-up posture) based on the sensor information (output results of the acceleration sensor 361 and the gyro sensor 362) acquired from the pet terminal 30. If the processor 11 detects that the pet terminal 30 is in the vertical state (step B9), it breaks the process of step B7 (step B10). Once the pet terminal 30 is placed in the horizontal state and then in the vertical state (head-up posture), this corresponds to a “special movement”.

After the vertical state at the pet terminal 30 was detected, the processor 11 of the smartphone 10 saves the pet terminal ID of the pet terminal 30 for which the special movement was detected in the special movement detection list in the RAM 13 (step B11). The processor 11 stops the individual analysis process for all the pet terminals 30 connected to the smartphone 10 (corresponding to the pet terminal IDs in the connected terminal list) (step B12). The processor 11 disconnects communication by the BLE communication unit 15 with the pet terminals 30 for which no special movement was detected (step B13).

If a predetermined time (for example, 10 seconds) has elapsed (step B14) since the timer started measuring in step B1 in the special movement analysis process (step S9), the processor 11 of the smartphone 10 stops the individual analysis process for all the pet terminals 30 connected to the smartphone 10 (step B15). The processor 11 disconnects communication by the BLE communication unit 15 with all the pet terminals 30 connected to the smartphone 10 (step B16). After step B13 or step B16, the special movement analysis process ends.

Returning to FIG. 3, the processor 11 of the smartphone 10 determines whether or not any of the pet terminals 30 have special movement detected as a result of the special movement analysis process. If there are no pet terminals 30 for which the special movement was detected (step S10), the processor 11 causes the display unit 17 to display a screen indicating that detection was not possible (step S11). The screen indicating that detection was not possible displays that the special movement could not be detected for any of the pet terminals 30. The processor 11 breaks the overall registration time process (step S12).

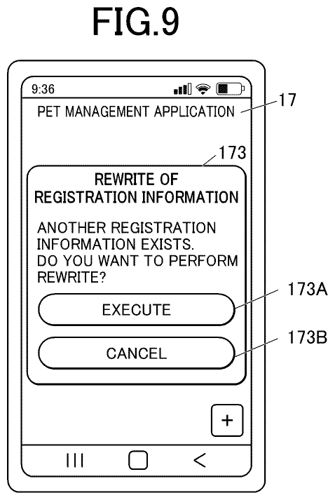

After the special movement analysis process (step S9), if there is a pet terminal 30 for which the special movement was detected, the processor 11 of the smartphone 10 determines whether or not the pet terminal 30 is a registered terminal (a terminal with a registered communication partner). Specifically, the processor 11 refers to the connected terminal list in the RAM 13 to determine whether or not the “registration status” associated with the “pet terminal ID” of the pet terminal 30 for which the special movement was detected is “registered”. The “pet terminal ID” of the pet terminal 30 for which the special movement was detected can be acquired from the special movement detection list. If the pet terminal 30 for which the special movement was detected is a registered terminal (step S13), the processor 11 causes the display unit 17 to display the registration confirmation screen 173 shown in FIG. 9 (step S14). The registration confirmation screen 173 is a screen to notify the user that another smartphone (registration information) has already been registered in the pet terminal 30 for which the special movement was detected, and to confirm whether or not the key information (registration information) stored in the storage unit 34 of the pet terminal 30 should be rewritten. The registration confirmation screen 173 includes an “execute” button 173A and a “cancel” button 173B. The “execute” button 173A is used to instruct the pet terminal 30 to rewrite the key information (register the user's smartphone 10 currently in operation). The “cancel” button 173B is used to instruct the pet terminal 30 to cancel the registration of the user's smartphone 10 currently in operation.

Next, the processor 11 of the smartphone 10 determines whether or not a cancel operation was performed by the user on the operation unit 16 of the smartphone 10. If the cancel operation was performed by the user (step S15), the processor 11 disconnects the communication by the BLE communication unit 15 with the pet terminal 30 for which the special movement was detected (step S16). The processor 11 breaks the overall registration time process (step S17).

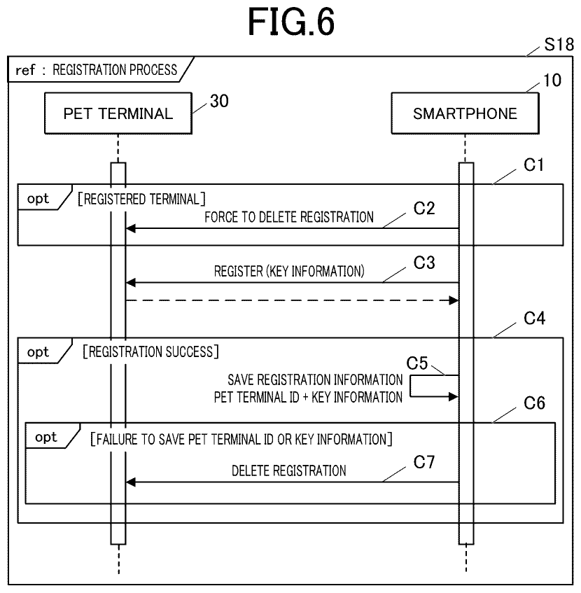

If there is a pet terminal 30 for which a special movement was detected and no cancel operation has been performed, the processor 11 of the smartphone 10 executes the registration process with the pet terminal 30 as the registration target (step S18). As shown in FIG. 6, in the registration process, the processor 11 determines whether or not the pet terminal 30 which is the registration target is a registered terminal. Specifically, the processor 11 refers to the connected terminal list in the RAM 13 to determine whether or not the “registration status” associated with the “pet terminal ID” of the pet terminals 30 which is the registration target is “registered”. If the pet terminal 30 which is the registration target is a registered terminal (step C1), the processor 11 forces the pet terminal 30 to delete the registration of the communication partner (key information) (step C2). Specifically, the processor 11 instructs the pet terminal 30 which is the registration target to delete the currently registered communication partner (key information) via the BLE communication unit 15. When the control unit 31 of the pet terminal 30 receives the deletion instruction of the communication partner via the BLE communication unit 35, it deletes the key information stored in the storage unit 34.

Next, the processor 11 of the smartphone 10 generates key information (authentication key). The processor 11 then transmits the key information to the pet terminal 30 which is the registration target via the BLE communication unit 15, to instruct it to register the smartphone 10 as the communication partner (step C3). When the control unit 31 of the pet terminal 30 receives the key information and the registration instruction via the BLE communication unit 35, it stores the received key information in the storage unit 34. In other words, the control unit 31 registers the smartphone 10 that generated the key information as the communication partner.

When the key information is successfully registered at the pet terminal 30, the control unit 31 of the pet terminal 30 transmits information indicating the successful registration and identification information (pet terminal ID) of the pet terminal 30 to the smartphone 10 via the BLE communication unit 35. The processor 11 of the smartphone 10 recognizes the successful registration of the key information at the pet terminal 30 by receiving the information indicating the successful registration and the pet terminal ID via the BLE communication unit 15. On the other hand, if the registration of the key information fails at the pet terminal 30, the control unit 31 of the pet terminal 30 transmits information indicating that the registration has failed to the smartphone 10 via the BLE communication unit 35. The processor 11 of the smartphone 10 recognizes the failure of registration of the key information at the pet terminal 30 by receiving the information indicating that the registration has failed via the BLE communication unit 15.

If the key information has been successfully registered at the pet terminal 30 (step C4), the processor 11 of the smartphone 10 saves the registration information in the storage unit 14 (step C5). The registration information includes the pet terminal ID of the pet terminal 30 of the communication partner and the key information used for communication with that pet terminal 30. If the save of the pet terminal ID or the key information in the storage unit 14 fails (step C6), the processor 11 causes the pet terminal 30 to delete the registration of the smartphone 10 itself made in step C3 (step C7). Then, the registration ends.

Returning to FIG. 3, after the registration process (step S18), the processor 11 of the smartphone 10 determines whether or not mutual registration with the pet terminal 30 was successful (step S19). Mutual registration includes registration of the key information at the pet terminal 30 and registration of the pet terminal ID and the key information at the smartphone 10.

If mutual registration between the smartphone 10 and the pet terminal 30 is successful (step S19; registration success), the processor 11 of the smartphone 10 causes the display unit 17 to display a registration success screen (step S20). After the registration success screen is displayed, the smartphone 10 can give predetermined instructions to the pet terminal 30 via the BLE communication unit 15.

If the mutual registration between the smartphone 10 and the pet terminal 30 fails (step S19; registration failure), the processor 11 of the smartphone 10 disconnects communication by the BLE communication unit 15 with the pet terminal 30 for which the special movement was detected (step S21). The processor 11 then causes the display unit 17 to display the registration failure screen (step S22). After step S20 or step S22, the overall registration time process ends.

If registration is completed between the smartphone 10 and the pet terminal 30, data communication can be performed with the registered communication partners using the already registered key information at the next communication.

As explained above, according to this embodiment, the processor 11 of the smartphone 10 (first electronic apparatus, electronic apparatus) performs the second process of instructing the user to change the posture of the pet terminal 30 (second electronic apparatus, another electronic apparatus) if the search in the terminal search process (first process) is successful. The processor 11 then performs the third process of registering the pet terminal 30, a change in posture of which has been detected. By instructing the user to perform an operation on the pet terminal 30 when the pet terminal 30 is detected, the processor 11 can prevent errors caused by the user performing an operation corresponding to a special movement while searching for the pet terminal 30. The processor 11 can also correctly detect the special movement by prompting the user to change the posture of the pet terminal 30. In this way, the processor 11 can run the registration process through the appropriate stages and register the pet terminal 30 (electronic apparatus) at a suitable time.

The processor 11 also causes the display unit 17 to display information indicating that the terminal search process is being executed at the execution of the terminal search process. After the completion of the terminal search process, the processor 11 causes the display unit 17 to display an image (special movement explanation screen 172) instructing the user to change the posture of the pet terminal 30. The processor 11 can display processes that are being executed so as to be distinguishable between the search phase of the pet terminal 30 and the detection phase of special movements in the pet terminal 30. The processor 11 can prevent the user from accidentally performing an operation to determine the communication partner during the period of searching for a candidate communication partner.

The change in posture at the pet terminal 30 is achieved by the user setting the pet terminal 30 to a predetermined posture position after the terminal search process. The processor 11 of the smartphone 10 can identify the pet terminal 30 with which the smartphone 10 communicates in response to manual operations by the user on the pet terminal 30.

The processor 11 of the smartphone 10 detects changes in posture at the pet terminal 30 based on the output results of the acceleration sensor 361 or the gyro sensor 362 provided in the pet terminal 30. This allows the processor 11 to easily detect changes in posture.

The smartphone 10 can also transmit predetermined instructions to the pet terminal 30. The pet terminal 30 can perform various movements in response to instructions received from the smartphone 10.

The description in the above embodiment is an example of the present invention and is not limited to this. The detailed configuration and detailed movement of each apparatus configuring the system can also be changed as appropriate to the extent not to depart from the intent of the present invention.

For example, the processor 11 of the smartphone 10 may not continue displaying of the terminal search screen 171 that was displayed by the display unit 17 in step S3, until the terminal search process (step S4) is completed. In this case, the user may perform the operation corresponding to the special movement after the special movement explanation screen 172 is displayed on the display unit 17 in step S8. In other words, the user may recognize the transition to the special movement detection phase when the special movement explanation screen 172 is displayed. The processor 11 of the smartphone 10 may not continue displaying of the special movement explanation screen 172 that was displayed by the display unit 17 in step S8 until the special movement analysis process (step S9) is completed.

In the above embodiment, the operation corresponding to the special movement is explained using the example of the operation to put the pet terminal 30 in a vertical state (head-up posture) after once putting it in a horizontal state, but the operation corresponding to the special movement is not limited to this example.

The above embodiment describes a case in which the processor 11 of the smartphone 10 detects a special movement (change in posture) at the pet terminal 30 based on sensor information acquired from the pet terminal 30. Alternatively, on the pet terminal 30 side, the control unit 31 may detect special movements at the pet terminal 30 based on the output results of the sensor unit 36 and communicate the detection results to the smartphone 10.

In the above embodiment, there was described a case in which the processor 11 of the smartphone 10 analyzes whether or not a special movement was performed at the pet terminal 30 based on the output results of the acceleration sensor 361 and the gyro sensor 362 acquired from the pet terminal 30. Alternatively, the processor 11 of the smartphone 10 may detect special movement at the pet terminal 30 based on the output results of other sensors. For example, the processor 11 may identify a pet terminal 30 which is the registration target by detecting that the user has tapped the pet terminal 30 consecutively for a predetermined number of times based on the output result of the touch sensor 363. The processor 11 may also identify the pet terminal 30 which is the registration target by detecting audio such as a user calling out to the pet terminal 30 based on the output result of the microphone 364.

In the terminal search process (FIG. 4), the number of pet terminals 30 that can be connected to the smartphone 10 is limited to three (step A11), but the maximum number of pet terminals 30 that can be connected to the smartphone 10 may be other than three. There may be no need to limit the number of pet terminals 30 that can be connected to the smartphone 10.

The computer-readable media that contain programs for executing each process are not limited to the above examples. Carrier waves may also be applied as a medium to provide program data via communication lines.

1. An electronic apparatus comprising:
a wireless communicator; and
one or more processors that perform a first process of searching for another electronic apparatus via the wireless communicator, a second process of instructing a user to change a posture of the other electronic apparatus in a case in which the searching in the first process is successful, and a third process of registering the other electronic apparatus, a change in the posture of which is detected.

2. The electronic apparatus according to claim 1, wherein the one or more processors perform control to display information indicating that the first process of searching for the other electronic apparatus is being executed at execution of the first process, and to display an image instructing the user to change the posture of the other electronic apparatus in the second process after completion of the first process.

3. The electronic apparatus according to claim 1, wherein the change in the posture is achieved by the user setting the other electronic apparatus to a predetermined posture position after the first process.

4. The electronic apparatus according to claim 1, wherein the one or more processors detect the change in the posture in the other electronic apparatus based on an output result of an acceleration sensor or a gyro sensor provided in the other electronic apparatus.

5. The electronic apparatus according to claim 1, wherein, in the case in which the searching in the first process is successful and a third process has been done for an electronic apparatus of a same type as a type of the other electronic apparatus, the third process for the other electronic apparatus is performed to overwrite the third process for the electronic apparatus of the same type.

6. A registration processing method that is an apparatus registration processing method between a first electronic apparatus and a second electronic apparatus, each including a wireless communicator, the method comprising:
a first step in which one or more processors of the first electronic apparatus perform a first process of searching for the second electronic apparatus via the wireless communicator of the first electronic apparatus;
a second step in which the one or more processors perform a second process of instructing a user to change a posture of the second electronic apparatus in a case in which the searching in the first process is successful; and
a third step in which the one or more processors perform a third process of registering the second electronic apparatus, a change in the posture of which is detected.

7. The registration processing method according to claim 6, wherein the first electronic apparatus is a communication terminal that transmits a predetermined instruction to the second electronic apparatus, and
the second electronic apparatus is a robotic terminal that operates by receiving the predetermined instruction from the first electronic apparatus.

8. A non-transitory computer-readable recording medium recording a program that causes a computer to function as one or more processors that perform a first process of searching for another electronic apparatus via a wireless communicator, a second process of instructing a user to change a posture of the other electronic apparatus in a case in which the searching in the first process is successful, and a third process of registering the other electronic apparatus, a change in the posture of which is detected.
